(19) United States
(12) Patent Application Publication
(10) Pub. No.: US 2005/0099297 A1
(43) Pub. Date: May 12, 2005

(54) Anti-theft device

(76) Inventors: Hui-Ming Tsai, Taichung City (TW); Chao-Chun Huang, Taiping City (TW)

Correspondence Address: Hart Baxley Daniels &Holton, 90 John Street, Suite 309, New York, NY, 10038, US

(21) Appl. No.: 10/705,326

(22) Filed: Nov. 10, 2003

(51) Int. Cl. G08B 13/12

(52) U.S. Cl. 340/568.2; 340/572.7

(57) ABSTRACT

An anti-theft device includes a main body including an insulating member, and a circuit board mounted in the insulating member. The insulating member has two opposite sides each formed with a plurality of torn portions, and the circuit board having two opposite sides each formed with a plurality of torn portions. Thus, when the thief pulls or breaks the object to reach the anti-theft device, the safety system detects the abnormal signal instantaneously so as to notify the security or guard, thereby providing an anti-theft function.

### BACKGROUND OF THE INVENTION

1. Field of the Invention

The present invention relates to an anti-theft device, and more particularly to an anti-theft device that can provide an anti-theft function to a smaller object, such as the window and a larger object, such as the wall.

2. Description of the Related Art

A conventional household anti-theft device comprises an anti-theft line mounted on the door or the window, and a safety system connected to the anti-theft line. Thus, when the thief breaks the anti-theft line, the safety system detects the abnormal signal instantaneously so as to notify the security or guard, thereby providing an anti-theft function. However, the anti-theft line usually has a stiff structure without any torn points, so that the anti-theft line is not easily broken, thereby decreasing the anti-theft effect.

### SUMMARY OF THE INVENTION

The primary objective of the present invention is to provide an anti-theft device that is available for a smaller object, such as the window.

Another objective of the present invention is to provide an anti-theft device that is available for a larger object, such as the wall.

A further objective of the present invention is to provide an anti-theft device, wherein when the thief pulls or breaks the object to reach the anti-theft device, the safety system detects the abnormal signal instantaneously so as to notify the security or guard, thereby providing an anti-theft function.

In accordance with the present invention, there is provided an anti-theft device, comprising:

a main body including an insulating member, and a circuit board mounted in the insulating member;

the insulating member having two opposite sides each formed with a plurality of torn portions; and

the circuit board having two opposite sides each formed with a plurality of torn portions.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of an anti-theft device in accordance with the preferred embodiment of the present invention;

FIG. 2 is an exploded perspective view of the anti-theft device as shown in FIG. 1;

FIG. 3 is a schematic view showing usage of the anti-theft device as shown in FIG. 1;

FIG. 4 is a perspective view of an anti-theft device in accordance with another embodiment of the present invention;

FIG. 5 is a perspective view of an anti-theft device in accordance with another embodiment of the present invention;

FIG. 6 is a perspective view of an anti-theft device in accordance with another embodiment of the present invention;

FIG. 7 is an exploded perspective view of the anti-theft device as shown in FIG. 6;

FIG. 8 is a schematic view showing usage of the anti-theft device as shown in FIG. 6;

FIG. 9 is a schematic view showing usage of the anti-theft device as shown in FIG. 8; and

FIG. 10 is a schematic view showing usage of the anti-theft device as shown in FIG. 8.

### DETAILED DESCRIPTION OF THE INVENTION

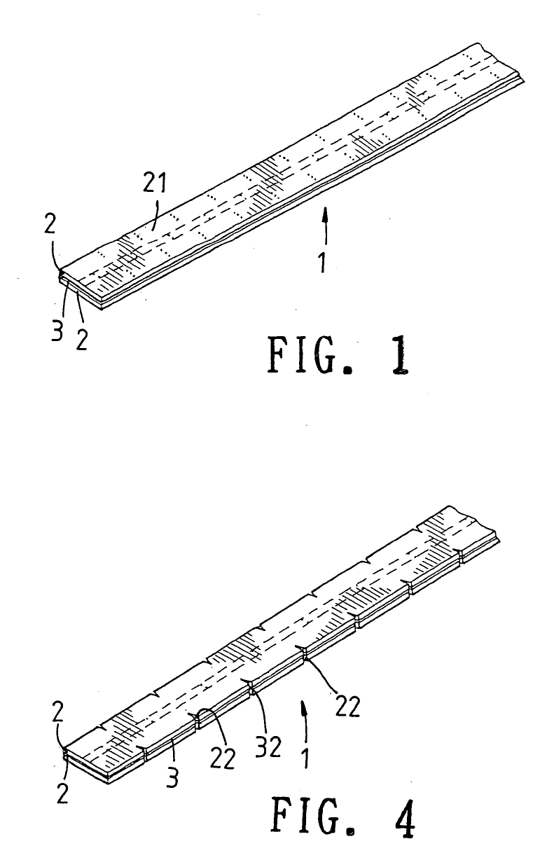

Referring to the drawings and initially to FIGS. 1 and 2, an anti-theft device in accordance with the preferred embodiment of the present invention comprises a main body 1 including two elongated flat insulating plates 2 laminated with each other to form an insulating member, and a circuit board 3 bonded between the two insulating plates 2.

The circuit board 3 has a length equal to that of each of the two insulating plates 2. The circuit board 3 has an inside provided with an anti-theft circuit having a length the same as that of the insulating member. Each of the two insulating plates 2 is made of plastic material and has two opposite sides each formed with a plurality of torn protrusions 21 formed by a press process, and the circuit board 3 has two opposite sides each formed with a plurality of torn protrusions 31 formed by a press process. Preferably, each of the torn protrusions 31 of the circuit board 3 is aligned with a respective one of the torn protrusions 21 of each of the two insulating plates 2.

Referring to FIG. 3, the main body 1 is mounted on an object, such as a window 4, and the anti-theft device further comprises a safety system 5 connected to the circuit board 3 of the main body 1 to supply an electric power to the anti-theft circuit of the circuit board 3 and to detect and identify the signal of the anti-theft circuit of the circuit board 3.

In practice, when the thief pulls or breaks the window 4 to reach the main body 1, the torn protrusions 31 of the circuit board 3 and the torn protrusions 21 of each of the two insulating plates 2 are torn, so that the main body 1 is broken and the signal of the anti-theft circuit of the circuit board 3 is shut. At this time, the safety system 5 detects that the signal of the anti-theft circuit of the circuit board 3 is shut and identifies entrance the thief so as to notify the security or guard, thereby providing an anti-theft function.

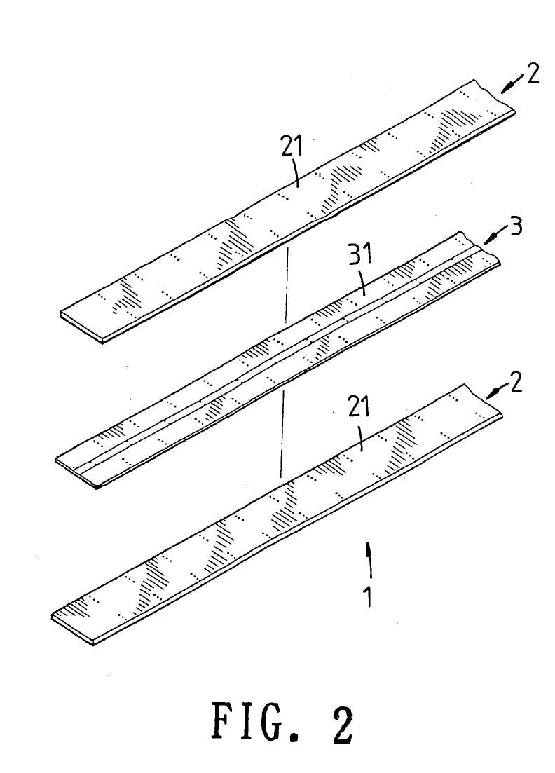

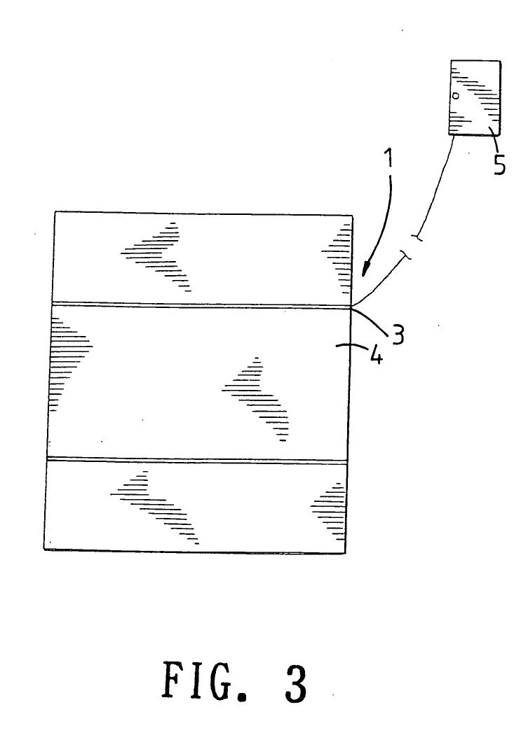

Referring to FIG. 4, each of the two insulating plates 2 has two opposite sides each formed with a plurality of torn notches 22 formed by a press process, and the circuit board 3 has two opposite sides each formed with a plurality of torn notches 32 formed by a press process. Preferably, each of the torn notches 32 of the circuit board 3 is aligned with a respective one of the torn notches 22 of each of the two insulating plates 2. In addition, the torn notches 22 at the two opposite sides of each of the two insulating plates 2 are arranged in a symmetrical manner, and the torn notches 32 at the two opposite sides of the circuit board 3 are arranged in a symmetrical manner.

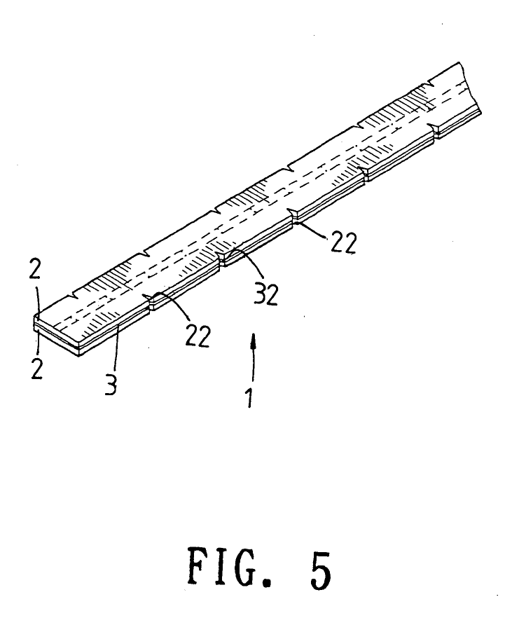

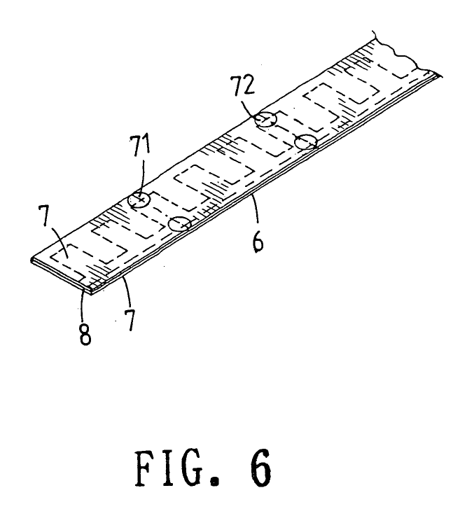

Referring to FIG. 5, the torn notches 22 at the two opposite sides of each of the two insulating plates 2 are arranged in a staggered manner, and the torn notches 32 at the two opposite sides of the circuit board 3 are arranged in a staggered manner.

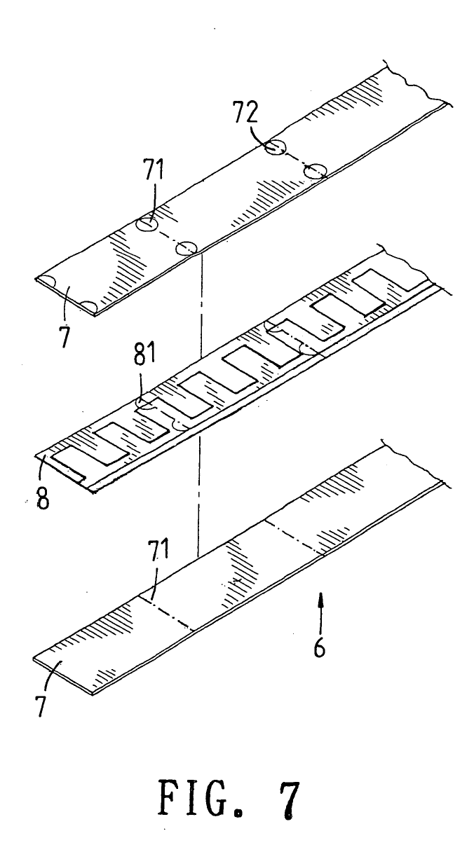

Referring to FIGS. 6 and 7, an anti-theft device in accordance with another embodiment of the present invention comprises a main body 6 including two elongated flat insulating plates 7 laminated with each other to form an insulating member, and a circuit board 8 bonded between the two insulating plates 7.

Each of the two insulating plates 7 has a surface formed with a plurality of cutting lines 71. Each of the cutting lines 71 of each of the two insulating plates 7 has two sides each formed with a torn opening 72.

The circuit board 8 has an area equal to that of each of the two insulating plates 2. The circuit board 8 has a surface formed with a plurality of cutting lines 81 each aligning with a respective one of the cutting lines 71 of each of the two insulating plates 7.

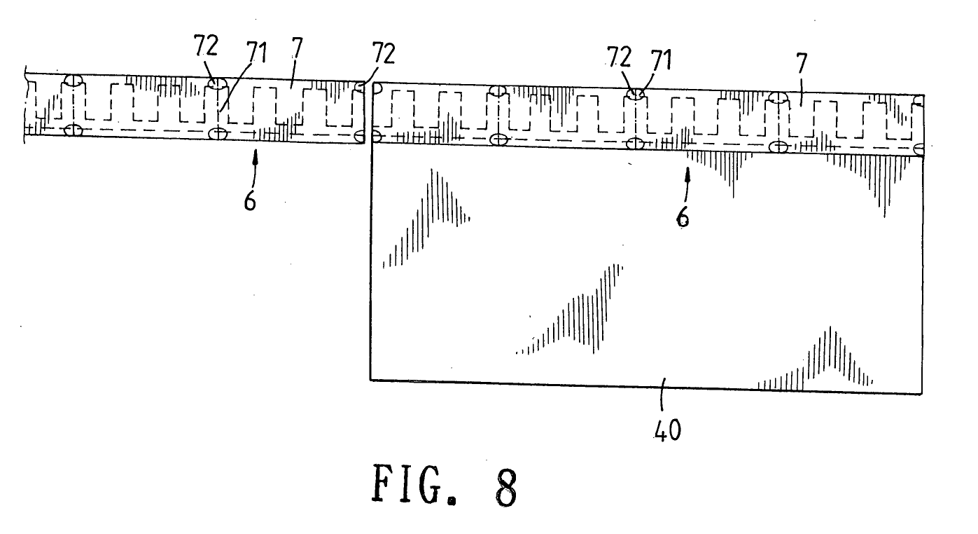

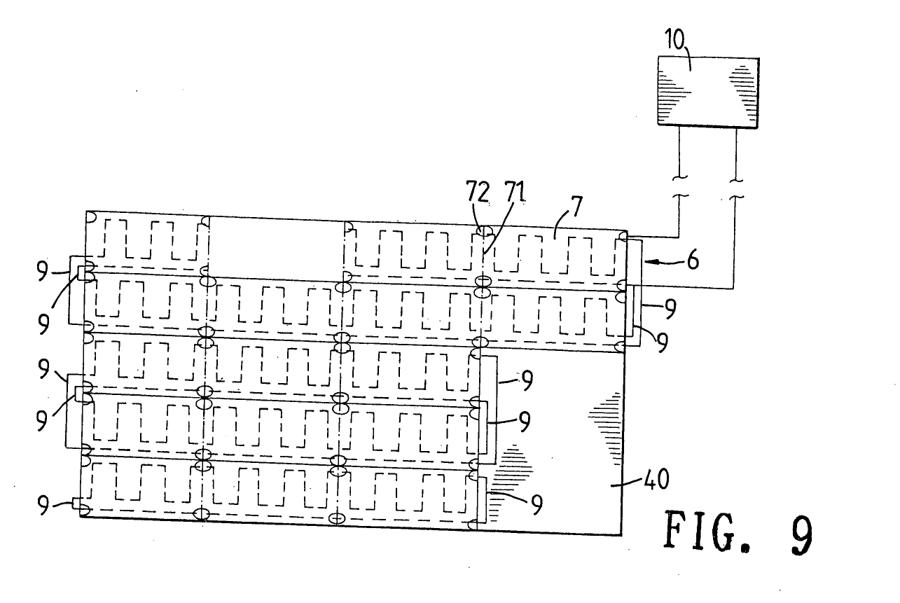

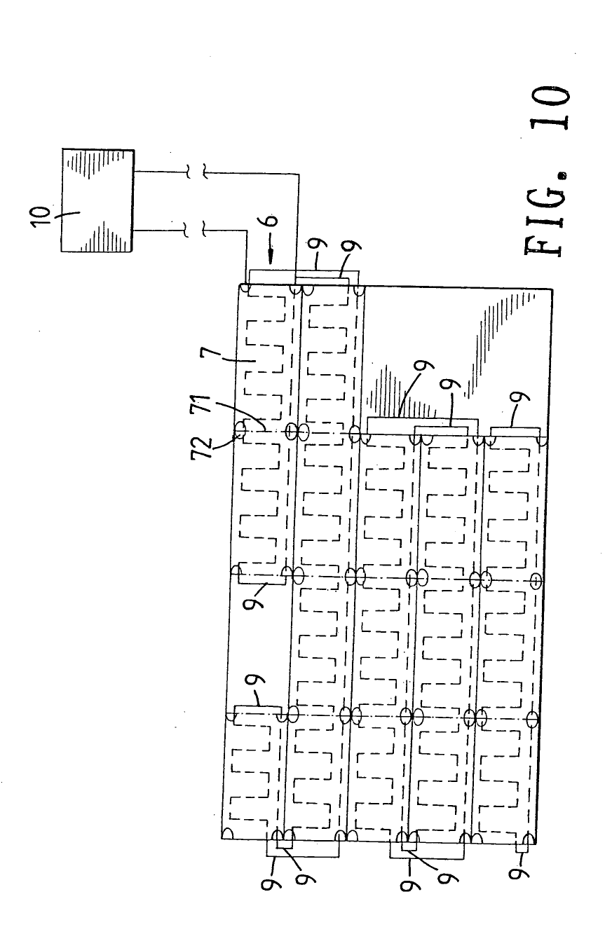

Referring to FIGS. 8 and 9, the main body 6 is mounted on an object, such as a wall 40, and the anti-theft device further comprises a safety system 10 connected to the circuit board 8 of the main body 6 to supply an electric power to the circuit board 8 and to detect and identify the signal of the circuit board 8.

When the main body 6 is bonded on the wall 40, one of the cutting lines 71 of each of the two insulating plates 7 is cut, and a respective one of the cutting lines 81 of the circuit board 8 is cut as shown in FIG. 8, so that partial of the main body 6 is cut, and the cut main body 6 is bonded on the wall 40 and is juxtaposed to the original main body 6. The above-mentioned procedure is repeated until the main bodies 6 are distributed over the whole wall 40 as shown in FIG. 9. At this time, the torn openings 72 at the two ends of each of the two insulating plates 7 are torn to expose the circuit board 8, and the circuit boards 8 of the juxtaposed main bodies 6 are connected by connecting wires 9, thereby forming a complete circuit over the whole wall 40 as shown in FIG. 9.

In practice, when the thief pulls or breaks the wall 40, one of the circuit boards 8 of the juxtaposed main bodies 6 are shut. At this time, the safety system 10 detects that the signal of the circuit board 8 is shut and identifies entrance the thief so as to notify the security or guard, thereby providing an anti-theft function.

Referring to FIG. 10, the connecting wires 9 are provided with at least one load (not shown). When the thief breaks the circuit board 8 to form a short circuit, the current after passing through the load is smaller than that before passing through the load, so that when the safety system 10 detects that the current is greater than the normal value,, the safety system 10 identifies entrance the thief so as to notify the security or guard, thereby providing an anti-theft function.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. An anti-theft device, comprising:
a main body including an insulating member, and a circuit board mounted in the insulating member;
the insulating member having two opposite sides each formed with a plurality of torn portions; and
the circuit board having two opposite sides each formed with a plurality of torn portions.

2. The anti-theft device in accordance with claim 1, wherein each of the torn portions of the insulating member is a tom protrusion, and each of the torn portions of the circuit board is a torn protrusion.

3. The anti-theft device in accordance with claim 1, wherein each of the torn portions of the insulating member is a torn notch, and each of the torn portions of the circuit board is a torn notch.

4. The anti-theft device in accordance with claim 1, wherein each of the torn portions of the insulating member is aligned with a respective one of the torn portions of the circuit board.

5. The anti-theft device in accordance with claim 1, wherein the torn portions at the two opposite sides of the insulating member are arranged in a symmetrical manner.

6. The anti-theft device in accordance with claim 1, wherein the torn portions at the two opposite sides of the insulating member are arranged in a staggered manner.

7. The anti-theft device in accordance with claim 1, wherein the torn portions at the two opposite sides of the circuit board are arranged in a symmetrical manner.

8. The anti-theft device in accordance with claim 1, wherein the torn portions at the two opposite sides of the circuit board are arranged in a staggered manner.

9. The anti-theft device in accordance with claim 1, further comprising a safety system connected to the circuit board of the main body to supply an electric power to the circuit board and to detect an abnormal signal of the circuit board.

10. The anti-theft device in accordance with claim 1, wherein the insulating member includes two elongated flat insulating plates laminated with each other, and the circuit board is bonded between the two insulating plates.

11. The anti-theft device in accordance with claim 10, wherein the circuit board has a length equal to that of each of the two insulating plates.

12. The anti-theft device in accordance with claim 1, wherein the insulating member has a surface formed with a plurality of cutting lines, and the circuit board has a surface formed with a plurality of cutting lines each aligning with a respective one of the cutting lines of the insulating member.

13. The anti-theft device in accordance with claim 12, wherein each of the cutting lines of the insulating member has two sides each formed with a torn opening.

14. The anti-theft device in accordance with claim 1, wherein the circuit board has a length equal to that of the insulating member.
